(19) United States
(12) Patent Application Publication
(10) Pub. No.: US 2022/0046315 A1
(43) Pub. Date: Feb. 10, 2022

(54) THINNING VIDEO BASED ON CONTENT

(71) Applicant: VERINT AMERICAS INC., Melville, NY (US)

(72) Inventor: Waleed Kouncar, Blainville (CA)

(21) Appl. No.: 17/330,656

(22) Filed: May 26, 2021

Related U.S. Application Data
(63) Continuation of application No. 13/315,703, filed on Dec. 9, 2011, now abandoned.
(60) Provisional application No. 61/422,201, filed on Dec. 12, 2010.

(51) Int. Cl. H04N 21/4335; H04N 21/45; H04N 21/44; G06Q 30/02; H04N 21/475

(52) U.S. Cl. CPC H04N 21/4335; H04N 21/4532; G06N 20/00; G06Q 30/0255; H04N 21/4755; H04N 21/44008

(57) ABSTRACT

In an embodiment, a method of thinning video captured of a scene comprises identifying and retrieving a segment of the video that occupies an amount of space in storage, processing the segment of the video to determine if the scene qualifies as of interest to a potential analysis of the video, and if the scene does not qualify as of interest to the potential analysis of the video, reducing the amount of space in storage occupied by the segment.

### RELATED APPLICATIONS

This non-provisional patent application is related to and claims priority to U.S. Provisional Patent Application No. 61/422,201, entitled “Thinning Video Based on Content,” filed on Dec. 12, 2010, which is hereby incorporated by reference in its entirety.

### TECHNICAL FIELD

Aspects of the invention are related to the field of reducing image storage space through image processing.

### BACKGROUND

Many common video systems include video cameras and video processing systems. The video processing system processes streams of video or images which are captured by the video cameras. After processing, the video processing systems store the video in video storage systems. Many video systems process and store the video in digital form.

Video systems are often used for surveillance and security applications. In many of these types of applications, video is captured for extended periods of time because the objective is to capture video of unexpected or infrequently occurring events. Consequently, video systems used for these types of applications often capture and store large quantities of video. These large quantities of video require large amounts of storage space and new video is typically being acquired and stored on an ongoing basis.

### Overview

What are disclosed are methods, systems, and software for thinning video captured of a scene.

In an embodiment, the method comprises identifying and retrieving a segment of the video that occupies an amount of space in storage, processing the segment of the video to determine if the scene qualifies as of interest to a potential analysis of the video, and if the scene does not qualify as of interest to the potential analysis of the video, reducing the amount of space in storage occupied by the segment.

In an embodiment, the system includes video storage configured to store video captured of a scene. The processing system is in communication with the video storage and configured to identify and retrieve a segment of the video that occupies an amount of space in the video storage, process the segment of the video to determine if the scene qualifies as of interest to a potential analysis of the video, and if the scene does not qualify as of interest to the potential analysis of the video, reduce the amount of space in the video storage occupied by the segment.

In an embodiment, a computer readable medium having stored thereon program instructions that, when executed by a video processing system to thin video captured of a scene, direct the video processing system to identify and retrieve a segment of the video that occupies an amount of space in storage, process the segment of the video to determine if the scene qualifies as of interest to a potential analysis of the video, and if the scene does not qualify as of interest to the potential analysis of the video, reduce the amount of space in storage occupied by the segment.

In an embodiment, if the scene does qualify as of interest to the potential analysis of the video, maintaining the amount of space in storage occupied by the segment.

In an embodiment, the scene qualifies as of interest if at least one object of interest is identified in the segment of the video.

In an embodiment, the scene qualifies as of interest if motion is identified in the segment of the video.

In an embodiment, the scene qualifies as of interest if motion in a direction of interest is identified in the segment of the video.

In an embodiment, the scene qualifies as of interest if the segment of the video was captured at a time of interest.

In an embodiment, the scene qualifies as of interest if motion of at least one object of interest is identified in the segment of the video.

In an embodiment, the scene qualifies as of interest if there are no other segments of video capturing the scene.

In an embodiment, the scene qualifies as of interest if previous accessing of the segment of the video is identified.

In an embodiment, the reduction of the amount of space in storage occupied by the segment is accomplished by at least one of the following: compressing, encoding, cropping, reducing resolution, removing color information, or removing intermediate frames.

### BRIEF DESCRIPTION OF THE DRAWINGS

FIG. 1 illustrates a video storage system;

FIG. 2 illustrates an operation of a video storage system;

FIG. 3 illustrates a video system;

FIG. 4 illustrates an operation of a video system;

FIG. 5 illustrates a video system;

FIG. 6 illustrates an operation of a video system;

FIG. 7 illustrates a video processing system.

### DETAILED DESCRIPTION

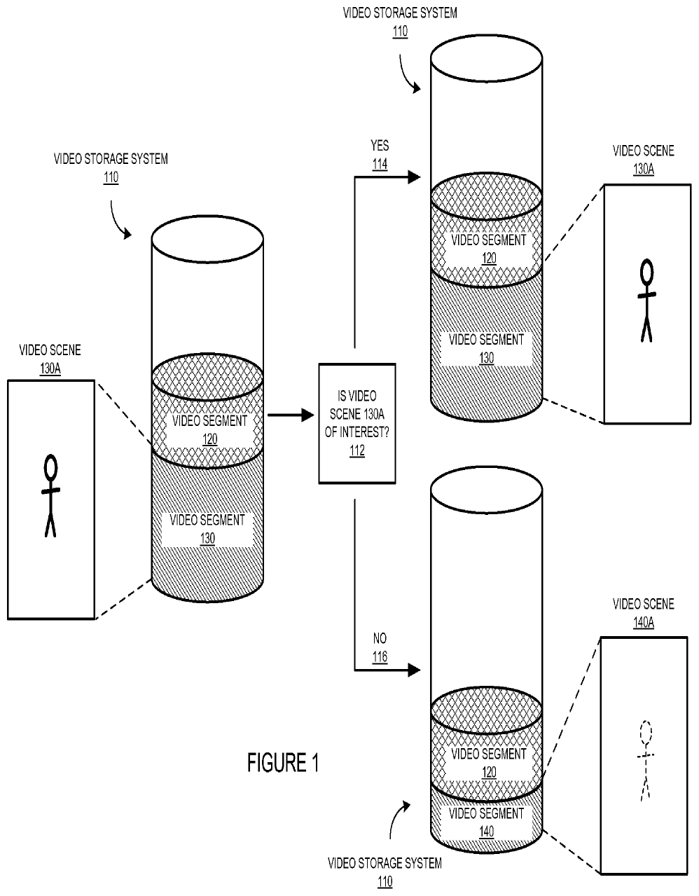

FIGS. 1-7 and the following description depict specific embodiments of the invention to teach those skilled in the art how to make and use the best mode of the invention. For the purpose of teaching inventive principles, some conventional aspects have been simplified or omitted. Those skilled in the art will appreciate variations from these embodiments that fall within the scope of the invention. Those skilled in the art will appreciate that the features described below can be combined in various ways to form multiple embodiments and variations of the invention. As a result, the invention is not limited to the specific embodiments described below, but only by the claims and their equivalents.

Video systems used for security or surveillance purposes often use one or more video sources to capture video of one or more scenes for purposes of monitoring people, objects, vehicles, or activities in those scenes. While some of the video may be viewed in real time, some of the video may also be stored for potential later viewing. The video may be viewed at a later time to investigate an accident, the location of an object, a person's behavior, a suspected activity, a transaction, or some other event which occurred, or may have occurred, within the scene.

In these security and surveillance applications, the events or incidents which may be of interest are typically not known ahead of time. Consequently, video is captured and stored over extended periods of time, if not continuously, in order to improve the chances of capturing unexpected, unplanned, or presently unknown incidents or occurrences. It is often not known when a need for the video may arise so it is desirable to store the video and have it available for use as long as reasonably possible in case a need arises. The desire to have the video available as long as possible is counterbalanced by the limited storage space which may be available in the video storage systems where the video is stored.

While compression and encoding techniques can significantly reduce the amount of storage space required to store video covering a certain period of time, some of these techniques are lossy and cause degradation, reductions in resolution, or reductions in the quality of the video. This reduction in quality may make the video less effective in subsequent uses. As a result, the amount of compression used must be counterbalanced against the amount of storage space available and the time period over which video storage is desired. Since storage space is limited and the video cannot be stored indefinitely, the oldest video is often deleted in order to free up space for new video in the video storage system. While deleting older video may not be ideal, the oldest video is often chosen for deletion because it is expected to be the least likely to be needed in the future.

In an alternate approach, a video processing system thins the older video segments rather than deleting them. Thinning involves further processing of the video segment in order to reduce the amount of storage space required to store it. Video is thinned by further compressing, processing, or encoding the video, and then storing the newly processed video segment in place of the original video segment. Video thinning may also be accomplished by cropping the video images to the area or areas of interest. The newly processed, or thinned, video segment now uses less storage space than it did previously but is now of lower quality or resolution. If a need to view video for that time period arises, the thinned video may still be useful and may provide a better result than would have been achieved had the video been deleted entirely.

FIG. 1 illustrates a video storage system. Video storage system comprises video storage system 110, video segments 120, 130, and 140. Video segments 120, 130, and 140 captured by video sources (not shown) are stored in video storage system 110. Video processing system (not shown) may retrieve video segments 120 and 130 from video storage system 110 and perform a number of processes, transformations, computations, modifications, conditioning, or other analytical processes thereon. Once these processes are complete, video processing system stores the processed video segment in video storage system 110 again. Video scenes 130A and 140A are examples of video scenes which may be stored in video storage system 110.

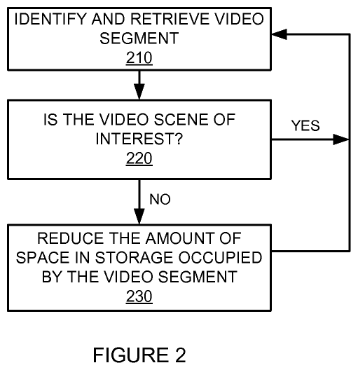

FIG. 2 illustrates an operation of a video storage system. The steps of the operation are indicated below parenthetically. A video processing system (not shown) identifies and retrieves video segment 130 from video storage system 110 (210). Other video segments, represented by video segment 120, also occupy and may be continually added to the finite storage space on video storage system 110. Video scene 130A represents a section of video segment 130 and was stored in a high resolution format with minimal compression such that a high level of detail is visible if and when video scene 130A is viewed or processed.

The video processing system processes video segment 130 to determine whether video scene 130A qualifies as of interest to a potential analysis 112 (220). Video scenes that may qualify as of interest include scenes containing objects of interest, scenes containing motion, scenes captured at a specific time of day, and so forth.

In one case, video scene 130A is determined to qualify as of interest to a potential analysis 114. In this case, the amount of storage space occupied by video segment 130 is maintained in video storage system 110 because video scene 130A may be of interest in future analysis. In other words, video scene 130A is not thinned, the resolution of video scene 130A is not reduced, and video scene 130A is not further compressed. As a result, the full benefit of the information in video segment 130 can be analyzed if used in the future.

In the alternate case, video scene 130A, corresponding to video segment 130, is determined to not qualify as of interest to a potential analysis 116. In this case, the amount of storage space occupied by video segment 130 is reduced to produce video segment 140 (230). Video scene 140A, corresponding to video segment 140, represents the resulting the thinned image of the high resolution video scene 130A. Video segment 140 and corresponding video scene 140A may be thinned by reducing resolution, increasing compression, removing color information, or performing some other process which reduces the amount of storage space needed to store the video segment.

Referring back to FIG. 1, video storage system 110 comprises any device for storing video or images. Video storage system 110 receives video from video sources and stores the video for later use or retrieval. Video storage system 110 comprises components for storage of data and an interface for receiving video or images. The storage components of video storage system 110 may comprise a disk drive, optical disk, flash memory, solid state memory, tape drive, or other device for storage of digital data, including combinations thereof. Video storage system 110 may also comprise additional interfaces for transmitting or receiving video or images, user interface software, power supply, or structural support. Video storage system 110 may be a server, disk array, database, or another device which provides storage of digital data.

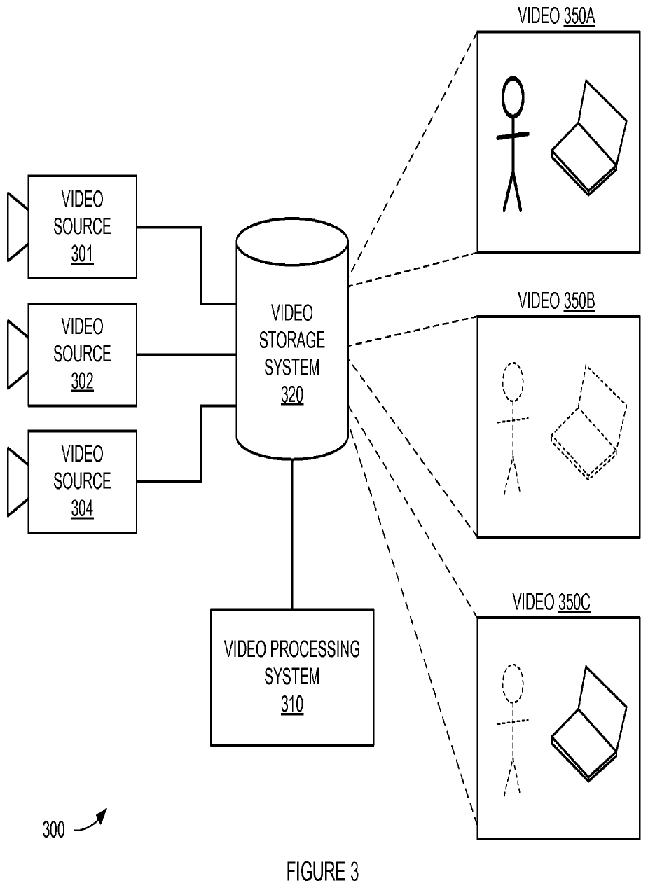

FIG. 3 illustrates video system 300. Video system 300 comprises video sources 301-304, video processing system 310, and video storage system 320. Video from video sources 301-304 is stored in video storage system 320. Video processing system 310 may retrieve video from video storage system 320 and perform a number of processes, transformations, computations, modifications, conditioning, or other analytical processes on the video. Once these processes are complete, video processing system 310 stores the video in video storage system 320 again. Videos 350A, 350B, and 350C are examples of video which may be stored in video storage system 320.

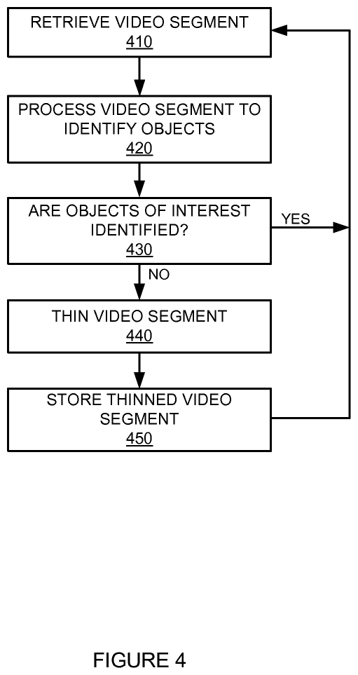

FIG. 4 illustrates an operation of video system 300. The steps of the operation are indicated below parenthetically. Video processing system 310 retrieves a video segment from video storage system 320 (410). The video segment, represented by video 350A in this example, was originally received from one of video sources 301-304 and stored in video storage system 320. Video 350A was stored in a high resolution format with minimal compression such that a high level of detail is visible if and when video 350A is viewed or processed.

Video processing system 310 processes the video segment and performs analysis on the video to identify objects in the video (420). In this example, the video includes a person and a laptop computer. If either of the objects identified in the video meet a criteria, it is more likely that the video may be of interest for use in the future. In this case, video 350A is left in its original form in video storage system 320 because the video may be of interest in the future based on the presence of the person or the computer, or both (430). In other words, the video is not thinned, the resolution of the video is not reduced, and the video is not further compressed. As a result, the full benefit of the information in the video can be realized if the video is used in the future.

In the alternate case, if the person and the computer in the video are not of interest and do not meet the criteria, the video segment is thinned (440). The thinned video segment is stored in video storage system 320 in place of the original video segment (450). This situation is illustrated by video 350B in FIG. 1. Video 350A is thinned by reducing the resolution, increasing the compression, removing color information, or performing some other process which reduces the amount of storage space needed to store the video segment. Video 350B is the result and is stored in video storage system 320 in place of video 350A thereby making additional storage space available in video storage system 320. Although it was determined that the objects in video 350A were likely not of interest, the video segment is still available in the form of video 350B with reduced quality or information content.

In a variation of the example above, video processing system 310 may thin only the portions of the video which contain objects which are not of interest. For example, video processing system 310 may process video 350A and determine that the computer is an object of interest but the person is not. In response to this situation, video processing system 310 thins or removes data from the portions of the image associated with the person while leaving all the detail relating to the computer intact. This results in video 350C. Video 350C is stored in video storage system 320 in place of video 350A. This frees storage space in video storage system 320 while keeping high quality video of the computer available. This partial thinning may be accomplished through compression, reductions in resolution, pixelation, removal of color data, or in other ways.

Referring back to FIG. 3, video sources 301-304 may comprise any device having the capability to capture video or images. Video sources 301-304 comprise circuitry, and an interface for transmitting the video or images. Video sources 301-304 may be the devices which perform the initial optical capture of the video segments or may be intermediate transfer devices. For example, video sources 301-304 may be video cameras, still cameras, internet protocol (IP) cameras, video switches, video buffers, video servers, or other video transmission devices, including combinations thereof.

Video processing system 310 may comprise any device for processing video, video streams, or images. Video processing system 310 comprises processing circuitry and an interface for transmitting video. Video processing system 310 is capable of performing one or more processes on video received from video sources 301-304. The processes performed on the video may include transformations, mathematical computations, modifications, analytical processes, conditioning, other processes, or combinations thereof. Video processing system 310 may also comprise additional interfaces for transmitting or receiving video, user interface, memory, software, communication components, power supply, or structural support. Video processing system 310 may be a video analytics system, server, computing system, or some other type of processing device, including combinations thereof.

Many surveillance and security uses of video systems result in video where there is motion. Video which has no motion will be much less likely to be of interest in the future. However, rather than deleting the video entirely, a video processing system may thin this video by reducing the resolution, compressing it further, removing intermediate frames, removing color information, or other thinning means, including combinations thereof. The video processing system then stores the thinned video in place of the original video thereby making more storage space available.

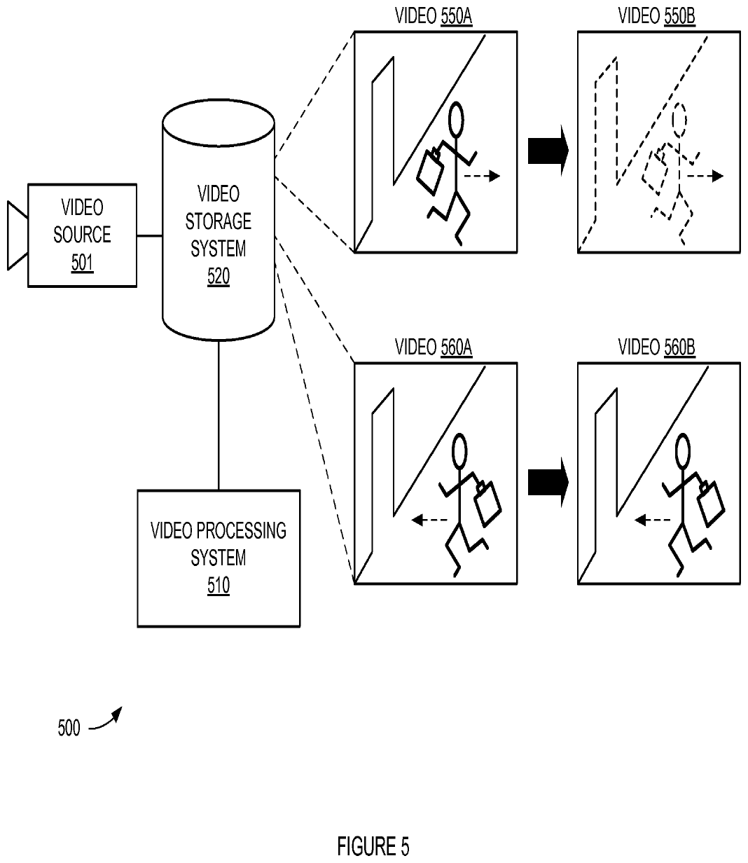

FIG. 5 illustrates another example of a video system which thins video based on content. In this case, video is thinned based on direction of motion. In some cases, video of people, objects, or vehicles leaving a building is of more interest than video of people, objects, or vehicles entering the building because the security activity is primarily concerned with unauthorized removal of objects or property from the building. A video processing system may have information indicating that left to right motion involves entry into the building while right to left motion is people or objects leaving the building. Based on this information, video segments containing left to right motion may be thinned while those containing right to left motion are not. In this way, the video segments containing motion which is potentially of most interest in the future, motion involving people or objects exiting the building, is kept at the original resolution and quality while the video which is likely of less interest, entrance into the building, is thinned. The thinning makes more storage space available but does not cause the video containing exit motions to be deleted entirely.

Video system 500 comprises video source 501, video processing system 510, and video storage system 520. Video from video source 501 is stored in video storage system 520. Video processing system 510 may retrieve video from video storage system 520 and perform a number of processes, transformations, computations, modifications, conditioning, or analytical processes on the video. Once these processes are complete, video processing system 510 stores the video in video storage system 520 again. Videos 550A, 550B, 560A, and 560B are examples of video which may be stored in video storage system 520.

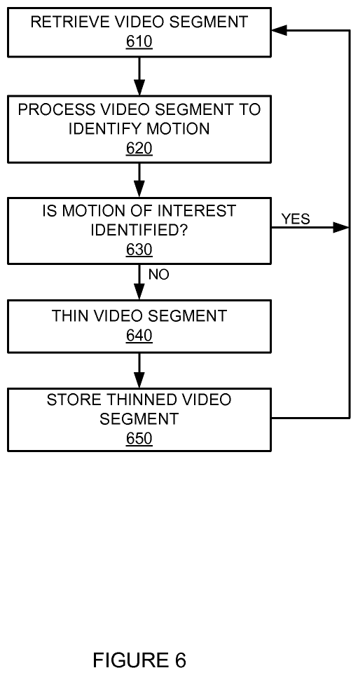

FIG. 6 illustrates an operation of video system 500. The steps of the operation are indicated below parenthetically. Video processing system 510 retrieves a video segment from video storage system 520 (610). The video segment, represented by video 550A in this example, was originally received from video source 501 and stored in video storage system 520. Video 550A was stored in a high resolution format with minimal compression such that a high level of detail is available if video 550A needs to be viewed or further processed.

Video processing system 510 processes the video segment and performs analysis on the video to identify motion in the video (620). In this example, video 550A includes a person carrying a bag entering a building. Video processing system 510 then determines if the motion meets a criteria (630). In this case, video of someone entering the building is of less interest so video 550A does not meet the criteria. Consequently, video processing system 510 thins the video (640). The thinned video is represented by video 550B. Thinned video segment 550B is stored in video storage system 520 in place of the original video segment (640).

FIG. 5 also illustrates an alternate scenario. Video 560A is another example of video captured by video source 501. Video 560A is video of a person with a bag leaving the building. In this case, video processing system 510 identifies the motion of someone or something exiting the building as motion of interest which meets a criteria (630). Therefore, video 560A is left in its original state or processed in a manner which retains all of most of the resolution in the video. In other words, video 560A is not thinned. Video 560A may be left in video storage system 520 in its original state or may be stored in a slightly different form, video 560B, which contains all or most of the information of interest.

It should be understood that the various types of thinning based on content discussed here may be used in various combinations. The type of thinning based on direction of motion discussed above may also be further refined based on time of day. At certain times of day, many people are expected to be entering or leaving a facility and the decision to thin video containing particular directions or types of motion may be further determined based on the expected activities at particular times of day. For instance, a large number of people are expected to be entering a building at the start of a work shift and a large number of people are expected to be leaving a retail establishment at closing time.

In another variation of thinning based on motion, a video processing system may thin video based on whether the motion is determined to be appropriate for the situation based on previously determined criteria. In one example, employees may be instructed to not move large objects unless at least two people are present. The video processing system thins the video containing large objects being moved where video processing and analysis algorithms have determined at least two people were present. At the same time, video of large objects being moved when it appears two people are not present is left at full resolution or quality for investigation, documentation, or training purposes.

In another variation of thinning based on motion, a warehouse operation may have a rule requiring that items only be moved to or from overhead storage if an aisle has been appropriately blocked. The video processing system leaves video segments at full resolution if it detects motion in overhead storage areas and barriers are not in place while thinning video segments involving this type of motion where barriers are in place. However, even if the barriers are in place, the video processing system may not thin the video if additional motion of some type is detected within the barricaded aisle.

In another variation of thinning based on motion, transactions involving cash or expensive items are often of greater security interest. The video processing system may make determinations as to whether to thin video based on whether the motion indicates access to these types of high value items or to area including these types of items. For instance, video segments with motion indicating the opening of a jewelry case or opening of a vault may not be thinned while other video of motion in the area may be thinned, or even deleted, because it is likely of less interest in the future.

In another variation of thinning based on motion, the video processing system may thin video based on whether motion in the video appears to be appropriate or expected. In one example, video involving fast or sudden movements may not be thinned while other video is thinned. This may be because fast or sudden movements are frequently associated with accidents, violence, threats, or reactions to emergencies. Video involving these types of movements has a much higher likelihood of future use for investigation, documentation, or evidentiary purposes.

In a different type of video thinning based on content, a video processing system thins video based on the type of objects present in the video. Stores and warehouses often contain objects of widely varying values. Video including scenes of high value items may be of greater interest and not subject to thinning while video of scenes involving low value items may be of much less interest. However, rather than deleting the video of the low value objects entirely, the video processing system thins this video by reducing the resolution, compressing it further, removing intermediate frames, removing color information, or by using other thinning means, including combinations thereof. The video processing system then stores the thinned video in place of the original video thereby making more storage space available.

In another example of thinning based on type of object, a return or repair facility may process or handle products of many types. The video associated with many of the lower value objects may be of little interest and be subject to thinning. However, any video associated with objects of higher value, laptops computers for example, may be retained at full resolution and quality without any thinning applied. Video processing system may detect different types of objects using many different types of image processing algorithms.

In a variation of the example above, tags or indicators which are recognizable by the video processing system may be attached to items which are either otherwise not easily recognizable or are packaged in a manner such that they cannot be easily identified. The tags are used to identify objects which are of particular interest. The video processing system uses the presence of these tags in the video to aid in determining which video should be thinned and which should not.

In another example of thinning based on type of object, the thinning determination may be made based on the presence of an unexpected object. For example, a particular type of facility may not allow guns or weapons. When video processing algorithms in the video processing system detect a potential gun or weapon, the associated video segment is not thinned while other video not containing these types of items is thinned to make additional storage space available.

In another example, the determination regarding whether a video segment will be thinned may be based on whether there are other video segments which already cover the scene during the same time period.

In the examples above, the determination as to whether a video segment should be thinned may be further based on whether the video segment has been previously accessed. Although a video segment may be subject to thinning based on content as described in any of the examples above, it may still be useful to leave the video segment in its original state if there is some indication that the video segment has already been previously accessed or viewed. In this way, automatic thinning may be avoided for video segments which are of interest or are currently being utilized.

It should be understood that the decision criteria associated with thinning based on type of motion or presence of objects as described in the examples above may also be combined with other thinning criteria. In other words, the decision to thin certain video based on the type of motion or type of object depicted may be further based on the age of the video, location the video was taken, time of day, or other criteria, including combinations thereof. In addition, video thinning may involve multiple levels or degrees of thinning. The determination as to which level of thinning is appropriate may also be based upon the motion in or the content of the video as described in the examples above.

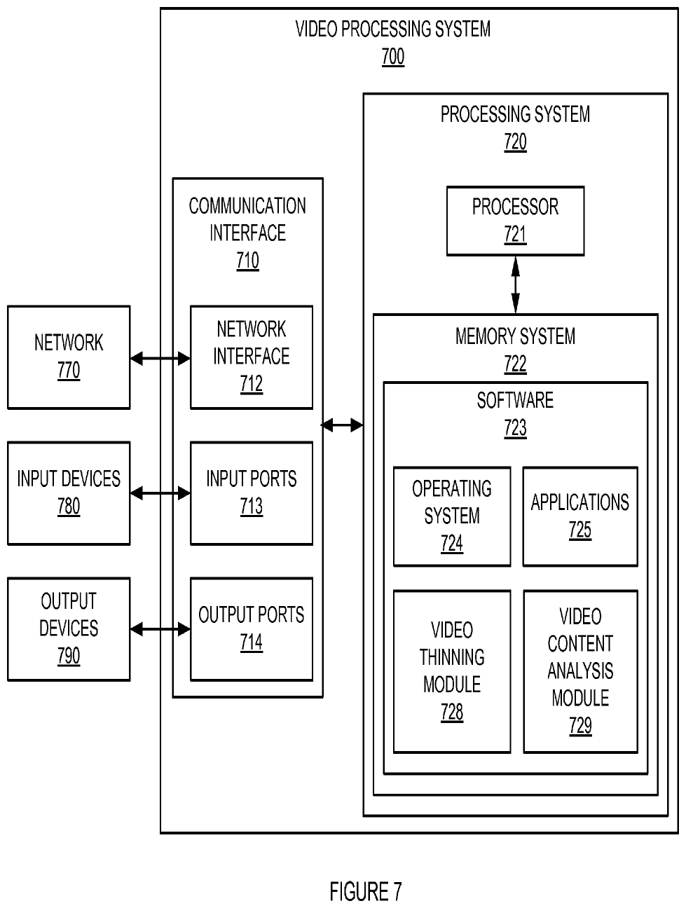

FIG. 7 illustrates video processing system 700. Video processing system 700 includes communication interface 710 and processing system 720. Processing system 720 is linked to communication interface 710 through a communication link. Processing system 720 includes processor 721 and memory system 722.

Communication interface 710 includes network interface 712, input ports 713, and output ports 714. Communication interface 710 includes components that communicate over communication links, such as network cards, ports, RF transceivers, processing circuitry and software, or some other communication device. Communication interface 710 may be configured to communicate over metallic, wireless, or optical links. Communication interface 710 may be configured to use TDM, IP, Ethernet, optical networking, wireless protocols, communication signaling, or some other communication format, including combinations thereof.

Network interface 712 is configured to connect to external devices over network 770. Input ports 713 are configured to connect to input devices 780 such as a video source, keyboard, mouse, or other input devices. Output ports 714 are configured to connect to output devices 790 such as a display, a printer, or other output devices.

Processor 721 includes microprocessor and other circuitry that retrieves and executes operating software from memory system 722. Memory system 722 comprises software 723. Memory system 722 may be implemented using random access memory, read only memory, a hard drive, a tape drive, flash memory, optical storage, or other memory apparatus.

Software 723 comprises operating system 724, applications 725, video thinning module 728, and video content analysis module 729. Software 723 may also comprise additional computer programs, firmware, or some other form of non-transitory, machine-readable processing instructions. When executed by processor 721, software 723 directs processing system 720 to operate video processing system 700 to process video as described herein using applications 725, make video thinning determinations using video content analysis module 729, and perform video thinning using video thinning module 728.

It should be understood that the functions and features of video processing system illustrated in FIG. 7 may be implemented in or performed by video processing system 710, video processing systems 710, by another device, or the functions may be distributed across multiple devices.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1-20. (canceled)

21. A method of thinning video captured of a scene, the method comprising:
providing a video storage system;
identifying and retrieving a segment of the video that occupies an amount of space in the video storage system;
determining at least two characteristics of content of the scene of the segment of the video, wherein the at least two characteristics determined are when at least two of the following is identified in the segment of the video:
(i) at least one object of interest;
(ii) motion;
(iii) motion in a direction of interest; or
(iv) motion of at least one object of interest;
processing the segment of the video to determine if the at least two characteristics satisfy criteria; and,
reducing the amount of space, the segment occupies in the video storage system
if the scene does not meet the criteria.

22. The method of claim 21, wherein at least a third characteristic is determined and the third characteristic includes if previous accessing of the segment of the video is identified.

23. The method of claim 21, wherein at least a third characteristic is determined and the third characteristic includes if the segment of the video was captured at a time of interest.

24. The method of claim 21, wherein the reduction of the amount of space in storage occupied by the segment is accomplished by at least one of the following: compressing, encoding, cropping, reducing resolution, removing color information, or removing intermediate frames.

25. A video system comprising:
a video storage configured to store video captured of a scene; and
a processing system in communication with the video storage, configured to:
identify and retrieve a segment of the video that occupies an amount of space in the video storage system;
determine at least two characteristics of content of the scene of the segment of the video, wherein the at least two characteristics determined are when at least two of the following is identified in the segment of the video:
(i) at least one object of interest;
(ii) motion;
(iii) motion in a direction of interest; or
(iv) motion of at least one object of interest;
process the segment of the video to determine if the at least two characteristics satisfy criteria; and,
reduce the amount of space, the segment occupies in the video storage system if the scene does not meet the criteria.
